(19) United States
(12) Patent Application Publication
(10) Pub. No.: US 2015/0025983 A1
(43) Pub. Date: Jan. 22, 2015

(54) SYSTEM AND METHOD FOR FACILITATING RESTAURANT ORDERS

(71) Applicant: Barkeep Mobile, LLC, Cleveland, OH (US)

(72) Inventor: Nick Cicerchi, Cleveland, OH (US)

(21) Appl. No.: 14/334,962

(22) Filed: Jul. 18, 2014

Related U.S. Application Data
(60) Provisional application No. 61/847,740, filed on Jul. 18, 2013.

(51) Int. Cl. G06Q 50/12; G06Q 20/40; G06Q 30/06

(52) U.S. Cl. CPC G06Q 50/12; G06Q 30/0633; G06Q 30/0641; G06Q 20/40
USPC 705/15

(57) ABSTRACT

A method for facilitating restaurant orders includes the step of communicating to a first computing device, data indicative a plurality of restaurants in proximity to the first computing device. The method further includes the step of communicating to the first computing device data indicative of a plurality of items associated with a selected restaurant of the plurality of restaurants. The method further includes the step of receiving data indicative of an order, comprising at least one item of the plurality of items, from the first computing device. The method further includes the step of communicating data indicative of the order to a second computing device associated with the selected restaurant. The method further includes the step of communicating, to the first computing device, data indicative of a change in status of the order.

### CROSS-REFERENCE TO RELATED APPLICATIONS

This application claims priority from U.S. Provisional Patent Application No. 61/847,740 filed on Jul. 18, 2013, which is incorporated by reference herein in its entirety.

### BACKGROUND

Restaurants and other types of businesses that prepare and serve food or drinks to customers require a process for taking food or drink orders and for collecting payment for such placed orders once the orders are delivered. Typically, a customer waits for a server or bartender or other type of Waitperson to manually capture an in-person order by listening to a customer speak an order and either writing down the order or keeping the order in memory until returning to a point of sale system to enter the order. After the order is delivered, the customer waits for a Waitperson to create and deliver the bill, collect the bill and payment, process the payment, and return the cash change or credit card receipt to the customer. The customer then manually signs a credit card receipt or manually counts change to leave a desired tip.

This ordering and payment collection process, however, may be inefficient and time consuming. In particular, this process may create bottlenecks that result in wait times for consumers before placing an order and making a payment. In addition, this process may be prone to errors. For example, a Waitperson may enter an erroneous or fraudulent charge on a credit card, incorrectly enter an order, mix up credit cards, give the customer the wrong change or the wrong credit card, and so on. Also, the customer may forget a credit card at a restaurant which can result in fraudulent purchases made using the credit card if found by a dishonest person.

In addition, customers in groups or parties may not be able to conveniently customize or divide up their orders and payment methods using the typical process described. When a group of friends collectively sit at a table or bar, existing orders and tabs may be taken and opened manually by a Waitperson or bartender without dividing up the order. At the end of the dining experience, the customers and Waitpersons may need to retroactively recap orders and align the orders with the customers' preferred payment methods, which may be inefficient and time consuming.

By focusing on transactional tasks such as writing, remembering, and entering orders, physically generating bills, and collecting payments, restaurant workers may not be able to properly focus on providing value-added selling and customer-oriented services for their clientele.

### SUMMARY

A system for facilitating restaurant orders includes at least one processor, at least one computer-readable tangible storage device, and program instructions stored on the at least one storage device for execution by the at least one processor. The program instructions include first program instructions to communicate to a first computing device, data indicative a plurality of restaurants in proximity to the first computing device. The program instructions further include second program instructions to communicate to the first computing device data indicative of a plurality of items associated with a selected restaurant of the plurality of restaurants. The program instructions further include third program instructions to receive data indicative of an order, comprising at least one item of the plurality of items, from the first computing device. The program instructions further include fourth program instructions to communicate data indicative of the order to a second computing device associated with the selected restaurant. The program instructions further include fifth program instructions to communicate, to the first computing device, data indicative of a change in status of the order, responsive to receiving, from the second computing device, data indicative of a confirmation of delivery of the order. The program instructions further include sixth program instructions to retrieve stored data indicative of a customer's preferred payment method, responsive to receiving a request to pay for the order. The program instructions further include seventh sixth program instructions configured to initiate a financial transaction with a third computing device using the retrieved preferred payment method.

A method for facilitating restaurant orders includes the step of communicating to a first computing device, data indicative a plurality of restaurants in proximity to the first computing device. The method further includes the step of communicating to the first computing device data indicative of a plurality of items associated with a selected restaurant of the plurality of restaurants. The method further includes the step of receiving data indicative of an order, comprising at least one item of the plurality of items, from the first computing device. The method further includes the step of communicating data indicative of the order to a second computing device associated with the selected restaurant. The method further includes the step of communicating, to the first computing device, data indicative of a change in status of the order, responsive to receiving, from the second computing device, data indicative of a confirmation of delivery of the order. The method further includes the step of retrieving stored data indicative of a customer's preferred payment method, responsive to receiving a request to pay for the order. The method further includes the step of initiating a financial transaction with a third computing device using the retrieved preferred payment method.

A system for facilitating restaurant orders includes a restaurant order computer server, a mobile customer computing device in data communication with the restaurant order computer server, and a mobile restaurant computing device in data communication with the restaurant order computer server. The mobile customer computing device includes at least one processor, at least one computer-readable tangible storage device, and program instructions stored on the at least one storage device for execution by the at least one processor. When executed, the program instructions cause the mobile customer computing device to receive a request from a customer to place an order for at least one item at a selected restaurant and wirelessly communicate the request to the restaurant order computer server. The program instructions further cause the mobile customer computing device to receive a status of the order from the restaurant order computer server and communicate to the customer the status of the order. The program instructions further cause the mobile customer computing device to receive authorization to initiate a payment transaction using a payment method associated with the customer, and communicate the authorization to the restaurant order computer server. The restaurant order computer server comprises at least one processor, at least one computer-readable tangible storage device, and program instructions stored on the at least one storage device for execution by the at least one processor. When executed, the program instructions cause the restaurant order computer server to communicate the order to the mobile restaurant computing device associated with the selected restaurant. The program instructions further cause the restaurant order computer server to receive notification of a status of the order from the mobile restaurant computing device and communicate the status of the order to the mobile customer computing device. The program instructions further cause the restaurant order computer server to receive authorization from the customer mobile computing device to initiate a payment transaction and initiate a payment transaction with a payment processing computer using the payment method associated with the customer.

### BRIEF DESCRIPTION OF THE DRAWINGS

In the accompanying drawings, structures are illustrated that, together with the detailed description provided below, describe example embodiments of the claimed invention. Where appropriate, like elements are identified with the same or similar reference numerals. Elements shown as a single component may be replaced with multiple components. Elements shown as multiple components may be replaced with a single component. The drawings may not be to scale. The proportion of certain elements may be exaggerated for the purpose of illustration.

FIG. 1 illustrates an example system for facilitating restaurant orders.

FIG. 2A is a screenshot of an exemplary customer mobile software application for use with the system of FIG. 1.

FIG. 2B is another a screenshot of an exemplary customer mobile software application for use with the system of FIG. 1.

FIG. 2C is another a screenshot of an exemplary customer mobile software application for use with the system of FIG. 1. FIG. 2C is another a screenshot of an exemplary customer mobile software application for use with the system of FIG. 1.

FIG. 2D is another a screenshot of an exemplary customer mobile software application for use with the system of FIG. 1.

FIG. 2E is another a screenshot of an exemplary customer mobile software application for use with the system of FIG. 1.

FIG. 3A is a screenshot of an exemplary merchant software application for use with the system of FIG. 1.

FIG. 3B is another a screenshot of an exemplary merchant software application for use with the system of FIG. 1.

FIG. 3C is another a screenshot of an exemplary merchant software application for use with the system of FIG. 1.

FIG. 4A is a screenshot of an exemplary portal software application for use with the system of FIG. 1.

FIG. 4B is another a screenshot of an exemplary portal software application for use with the system of FIG. 1.

FIG. 5 is a screenshot of an exemplary portal software application for use with the system of FIG. 1.

FIG. 6 is a block diagram of an exemplary restaurant order server of FIG. 1.

FIG. 7 is a flow chart illustrating an exemplary method for facilitating restaurant orders.

FIG. 8 is a block diagram of an exemplary computing system for implementing an example system for facilitating restaurant orders.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computing device,” as used herein, refers to a laptop computer, a desktop computer, a smartphone, a personal digital assistant, a cellular telephone, a tablet computer, or the like.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Restaurant,” as used herein, refers to a merchant or a business that prepares and serves food or drinks to customers and includes but is not limited to bars, night clubs, country clubs, social clubs, dine-in restaurants, and take-out restaurants.

A “Waitperson,” as used herein, refers to any employee or agent of a Restaurant that receives restaurant orders from a customer, delivers restaurant orders to a customer, process customer payments for a restaurant, or performs other similar customer service functions at a restaurant.

“Software,” as used herein, includes but is not limited to, one or more computer or processor instructions that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system, or other types of executable instructions. The form of software may depend, for example, on requirements of a desired application, the environment in which it runs, or the desires of a designer/programmer or the like. Computer-readable or executable instructions can be located in one logic or distributed between two or more communicating, co-operating, or parallel processing logics and, thus, can be loaded or executed in serial, parallel, massively parallel, and other manners. One form of software is an app, or an application that executes on a mobile computing device such as a mobile phone.

Suitable software for implementing the various components of the example systems and methods described herein may be produced using programming languages and tools like Haskell, Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

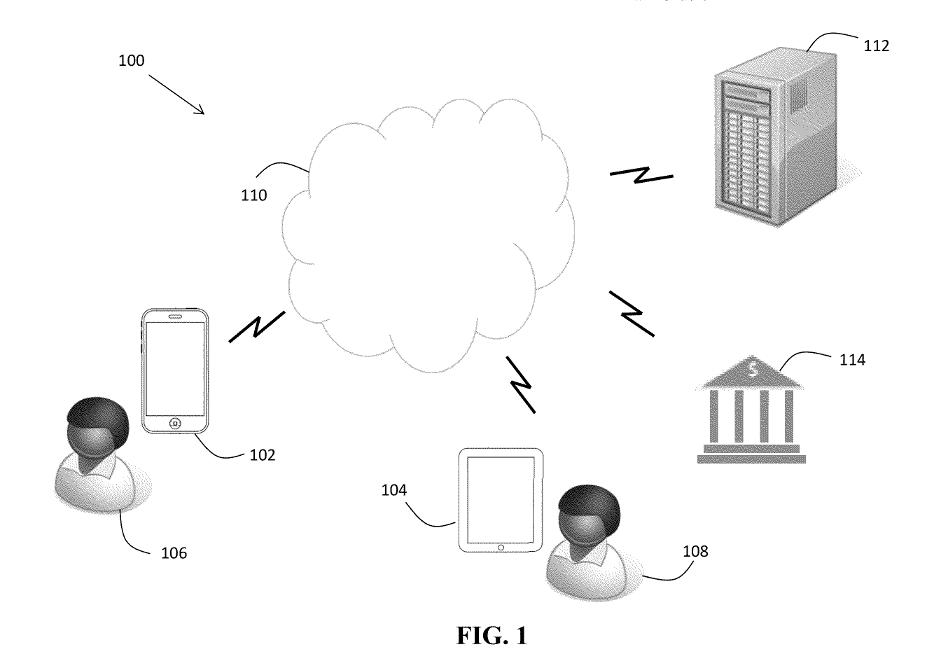

FIG. 1 illustrates an example system 100 for facilitating restaurant orders. The bottlenecks, inconveniences, and security risks of a manual ordering and payment credit card “swipe” process is improved on by system 100, which leverages a customer device 102 such as a smartphone, tablet computer, or other mobile computing device including a customer mobile software (not shown), (hereinafter referred to as “the customer device”) and a restaurant device 104 such as for example a tablet computer, smart phone, or custom handheld device that includes merchant software (not shown), (hereinafter referred to as “the restaurant device”).

Since system 100 can leverage a customer device 102, such as a smartphone or tablet computer, which a customer already owns and typically carries into a restaurant, the need for a restaurant to provide a customer with a point of sale device for placing orders is eliminated. Instead, a customer can be directed to download a customer mobile software application from iTunes or from Google Play, for example. In one example, a customer may be directed to download the software application by being asked to scan a QR code with a customer device 102.

It should be appreciated that, although customer device 102 and restaurant device 104 are referred to as including customer mobile software and merchant software respectively, customer device 102 and restaurant device 104 may also be configured to access cloud-based customer mobile software and merchant software over a network 110 via a web browser, instead of being configured with the software.

It should be understood that, although the customer device 102 is illustrated as a smartphone and the restaurant device 104 is illustrated as a tablet computer, the customer mobile software and the merchant software may be configured to run on any suitable computing device.

System 100 provides a benefit to a restaurant since system 100 enables servers, bartenders, or other Waitperson to minimize the time spent taking and processing orders and payments and instead to spend more time and energy focused on tasks that add value such as delivering a quality order, selling/upselling/cross-selling, providing a quality service, and enhancing experience for customers. System 100 also provides benefits to the customer since system 100 enables a customer to split or separate bills or create individualized bills, eliminates the need for customers to carry credit cards and the need for credit card “swiping” which eliminates the risk credit cards being lost or stolen, and also enables a more efficient and less error prone ordering process for the customer.

The customer device 102 can be configured to enable a customer 106 to place an order, for food or drink for example, at a restaurant as well as to pay for the order. The restaurant device 104 can be configured to enable a Waitperson 108 to receive an order from the customer 106, via the customer device 102, regardless of physical locations of customer 106 and the Waitperson 108. In particular, customer device 102 and restaurant device 104 communicate via a network 110 such as the Internet. Thus, a customer 106 may place an order using customer device 102 before entering a restaurant or while at the restaurant. Similarly, a customer 106 may pay for an order at any time after placing an order, before entering the restaurant, while at the restaurant, or after leaving the restaurant, as long as the customer device 102 is able to connect to the network 110.

It should be appreciated that although the customer device 102 and the restaurant device 104 are illustrated as communicating wirelessly via network 110, customer device 102 and restaurant device 104 may communicate using any suitable wireless or wired communication protocol. It should be further understood that although network 110 can be referred to as the Internet in examples described herein, network 110 can also be an intranet, a wireless or wired network, a cellular network, a satellite network, or any other suitable network, or any combination of networks.

System 100 includes a restaurant order server 112 that can be configured to process orders and payments. Restaurant order server 112 can be any computing device suitable for processing orders and payments, such as a computer server, a desktop computer, a laptop computer, and so on. The restaurant order server 112 can be distinct and remote from any particular restaurant and can be configured to process orders and payments for multiple geographically dispersed restaurants.

The customer device 102 and the restaurant device 104 both communicate with the restaurant order server 112, via network 110, to facilitate efficient processing of orders and payments. In particular, a customer device 102 can be configured to communicate an order to the restaurant order server 112 which can be configured to communicate the order to the Waitperson 108 via the restaurant device 104. The restaurant order server 112 is also configured to receive payment information from the customer device 102 and to communicate the payment information to a payment processing center 114, which processes payments for the restaurant. Payment processing center 114 may include one or more computing devices, for example. Thus, system 100 facilitates efficient transactions because a restaurant is not required to have any knowledge of or affiliation with the customer since the restaurant order server 112 facilitates the transactions. In other words, the restaurant doesn't need to provide the customer with any specific point of sale hardware or software and the customer isn't required to register with or provide any specific identification to any particular restaurant. System 100 simply requires a restaurant to have a restaurant device 104 configured to either download or access a cloud-based merchant software application and that a customer have a customer device 102 configured to either download or access a cloud-based customer mobile software application.

It should be appreciate that customer device 102, restaurant device 104, restaurant order server 112 and payment processing center 114 may be geographically dispersed and therefore may interact with one another via network 110 without regard for proximity or location. In one example (not shown), system 100 may include multiple Waitpersons 108 interacting with multiple restaurant devices 104 at multiple restaurants located in different geographic locations. Similarly, system 100 may include multiple customers 106 interacting with multiple customer devices 102 at multiple restaurants located in different geographic locations.

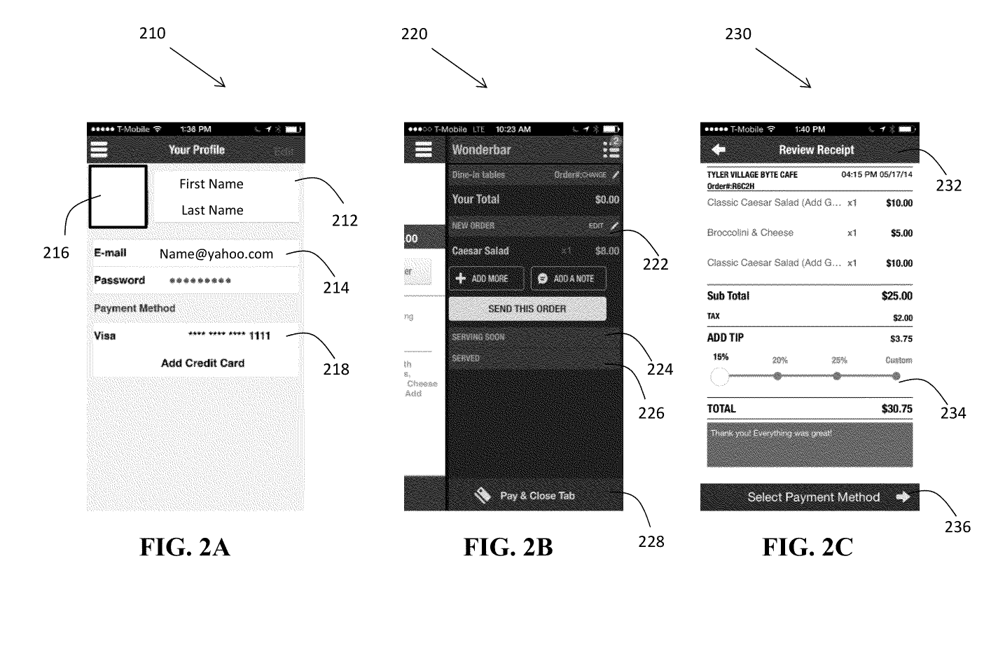

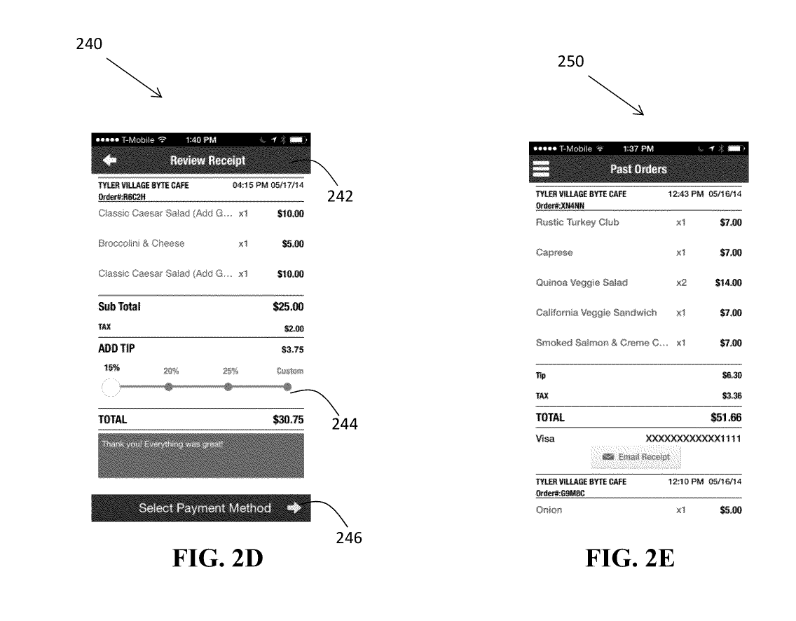

FIG. 2A is an example screen shot of an example user interface 210 of a customer mobile software application. User interface 210 enables a customer 106 to register with restaurant order server 112 by providing information such as first and last name 212 and an email address and password 214. In one example, user interface 210 enables a customer 106 to register or login using a single sign-on with social media account credentials such as a Facebook account username and password.

User interface 210 also enables a customer 106 to provide a photograph via a photo display and upload interface 216. The photo is later provided to the server 108 as an added layer of security so that a Waitperson 108 can verify the identity of a customer 106. User interface 210 also enables a customer 106 to provide credit card information 218 that will be associated with the customer's 106 orders. This allows the consumer 106 to efficiently pay for orders using stored credit card information without having to carry a credit card when visiting a restaurant. Credit card information may be entered manually or the information may be scanned automatically by using a built in camera of a customer device 102. A customer 106 may choose to associate multiple credit cards with an account and select one of the credit cards as a default credit card. It should be understood that user interface 210 may be configured to collect other suitable customer information during a registration process.

Once registered, a customer 106 may select a restaurant from a list of participating restaurants and proceed with an order. A customer 106 may search for a restaurant by name, by location, or using other suitable criteria. In one example, prior to or after registering, a customer 106 may be asked to opt-in for location-based services in order to geo-locate restaurants nearby. In other words, a customer 106 may be asked to grant the customer mobile software application permission to access a customer device's 102 location services in order for the mobile software application to be able to identify restaurants proximate to the customer's 106 current location.

FIG. 2B is another example screen shot of an example user interface 220 of a customer mobile software application that enables a customer 106 to create and manage orders once a restaurant is identified. User interface 220 includes a “new order” interface tab 222 that enables a customer 106 to create a new order and add items from a list of predetermined items associated with a selected restaurant's menu. Menu items may be searched for by name, by category, by prices, or by any suitable search criteria. In one example, user interface 220 provides information about a menu item, such as a photograph of the menu item, ingredients of the item, nutritional information about the menu item, whether the menu item meets certain dietary restrictions, or other suitable information about the menu item. In one example, user interface 220 enables a customer 106 to review menu items for a selected restaurant without opening a new order.

New order input interface tab 222 also enables a customer 106 to add notes to an order or to a specific item if the customer 106 wishes to provide special instructions to a Waitperson 108. For example, a customer 106 may add a note in order to request that a hamburger be cooked well done. FIG. 2C is an example screen shot of an example user interface 230 of a customer mobile software application that enables a customer 106 to add a note to an order.

Referring back to FIG. 2B, a “send this order” button in the new order interface tab 222 can be configured to initiate communication of an order to a restaurant. In one example, user interface 220 can be configured to request a customer location when an order is submitted. For example, in order to facilitate efficient delivery of the order to the customer 106, user interface 220 may require the customer to specify whether the customer is sitting inside the restaurant, outside in the patio, or whether the customer had not yet arrived at the restaurant.

It should be understood that although various buttons and other user interface controls and graphics are described in the examples herein, other suitable user interface controls can be used such as dials, knobs, check boxes, dropdown lists, and so on.

A “submitted order” interface tab 224 can be configured to display pending orders or orders that have been placed but not yet delivered to the customer 106. In one example, user interface 220 can be configured to enable the customer 106 to submit multiple orders and therefore have multiple orders pending simultaneously, either at the same restaurant or at different restaurants. Accordingly, unique order numbers may be assigned to each order for efficient tracking and management of orders. Thus, user interface 220 can be configured to enable a customer 106 to efficiently view the details of multiple pending orders.

A “completed” interface tab 226 can be configured to display orders that have been delivered to the customer 106. In one example, the “completed” interface tab 226 enables a customer 106 to view the details of a completed order and to repeat or re-order the same item or items with a single button click, without requiring searching for the same item again and adding it to an order. Thus, if a customer 106 frequents a particular restaurant, the customer 106 can efficiently reorder items that were included on a previous order without spending time on searching for the item.

Thus, by providing the user with three separate interface tabs 222, 224, and 226, or buckets of orders, the user is ably to efficiently determine the status of multiple orders.

In one example, the user interface 220 can be configured to provide a notification, including a visual notification, an audible notification, or a combination of both a visual and an audible notification, to indicate a change in order status. For example, user interface 220 may cause the customer device 102 to vibrate when an order status changes.

A “pay and close” interface tab 228 enables a customer 106 to initiate the process of paying for an order and closing the order. FIG. 2D is an example screen shot of an example user interface 240 of a customer mobile software application for closing orders. User interface 240 includes an “order summary” tab 242 that can be configured to display a summary of items ordered including prices for each item and a subtotal for all items. User interface 240 includes a “gratuity” tab 244 that enables a customer 106 to specify a gratuity or tip amount to be added to the total amount. User interface 240 may include a selection of default gratuity amounts or a slider bar or other similar user interface control for selecting a gratuity amount.

User interface 240 includes a “select payment method” tab 246 that enables a customer 106 to select a payment method and to initiate communication of payment information to the payment processing center 114. In one example, a customer 106 can view payment receipts for one or more past orders using a payment history interface 250, as illustrated in FIG. 2E.

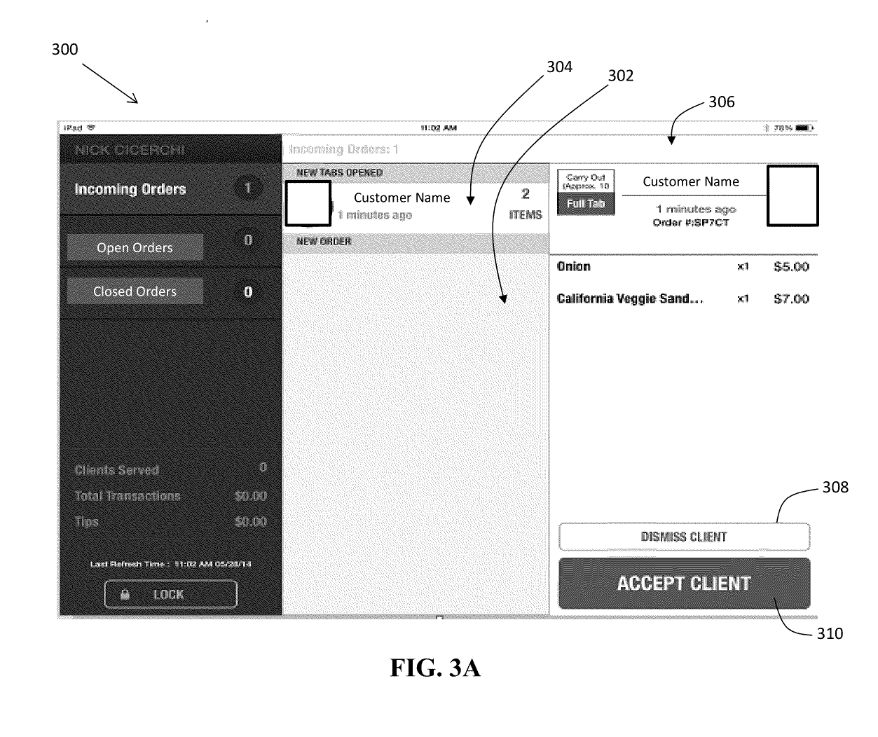

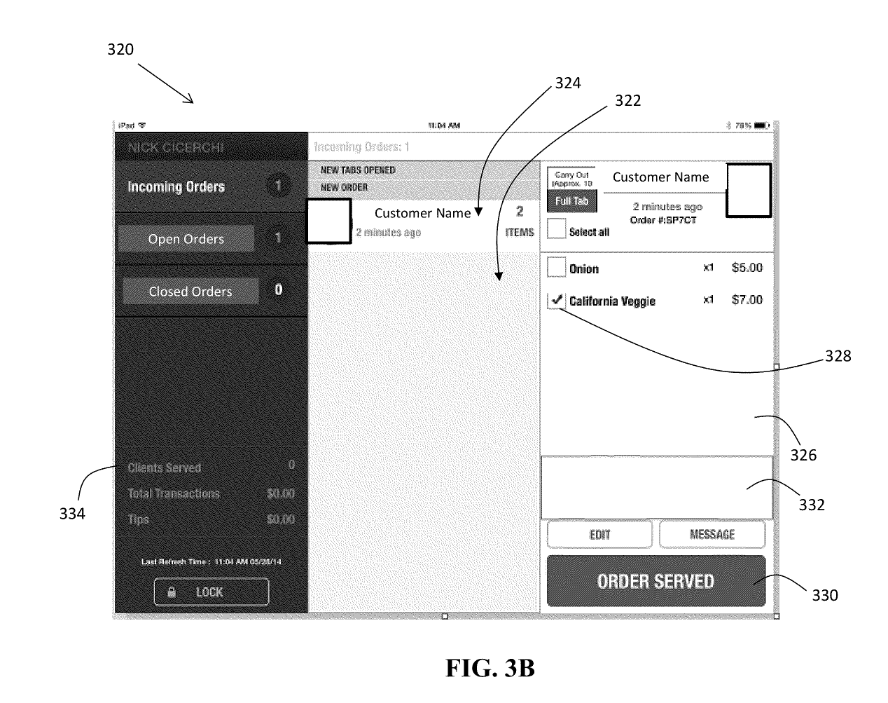

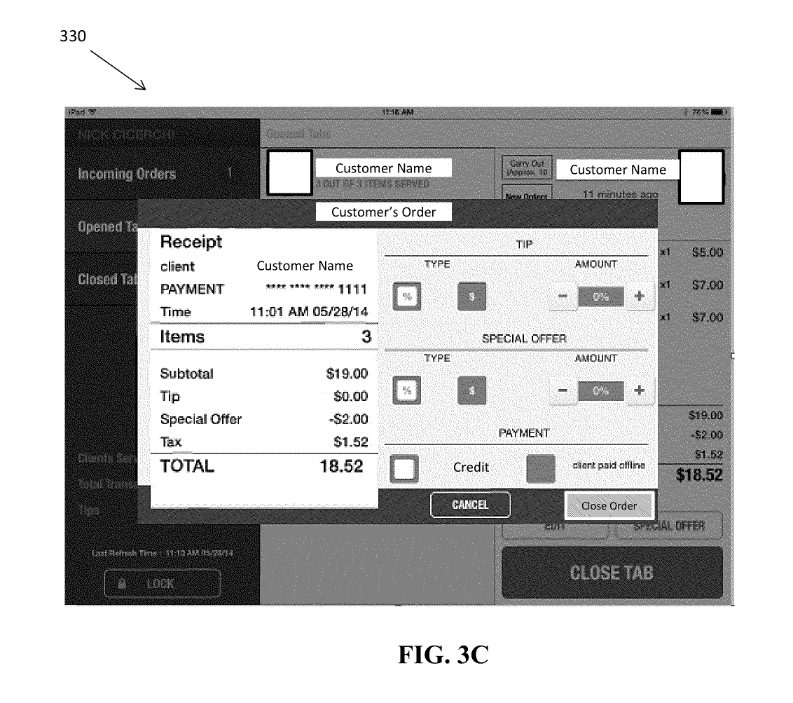

FIG. 3A is an example screen shot of an example user interface 300 of a merchant software application. User interface 300 enables a Waitperson 108 to view and manage incoming orders received from customers via a customer mobile software application, after a Waitperson's 108 identity is confirmed via a login screen (not shown).

In one example, the merchant software application may require login credentials at both a restaurant device level as well as from a Waitperson 108 level. For example, system 100 may require an administrator to present login credentials via the restaurant device 104 before the restaurant device is granted access to communicate with restaurant order server 112, after which a Waitperson 108 may be required to provide login credentials before being granted individual access to view and manage orders. This may help multiple Waitpersons 108 manage orders more efficiently via a single restaurant device 104. For example, incoming orders may be allocated to a particular Waitperson 108. Thus, user interface 300 may be configured to enables a Waitperson 108 to view and manage only incoming orders allocated to Waitperson 108.

User interface 300 can include an “incoming orders” panel 302 configured to display a summary of incoming orders 304. A summary of an incoming order 304 may include information such as a customer's name, how many items the customer has ordered, and how long ago the order was received, or other suitable information about an order.

User interface 300 also includes an “order details” panel 306 configured to display the details of a selected incoming order 304. The order details panel 306 can be configured to display information such as a list of items included in the order, the quantity of each item, the cost of each item, or other suitable information about an incoming order. In one example, the order details panel 306 can be configured to display a photograph of the customer 106 to allow the Waitperson 108 to confirm a customer 106 identity when delivering an order.

User interface 300 also enables a Waitperson 108 to dismiss an incoming order via a “dismiss” button 308 or to accept an incoming order via an “accept” button 310. For example, user interface 300 enables a Waitperson 108 to dismiss an incoming order if the Waitperson 108 believes the order to be a mistake. Dismissing an incoming order may include deleting the order or forwarding the order to a manager for further review, for example.

The “accept” button 310 can be configured to initiate a process for fulfilling the order. Accepted orders are placed into an “open orders” queue. FIG. 3B is another example screen shot of an example user interface 320 of a merchant software application. User interface 320 enables a Waitperson 108 to view and managing open orders. User interface 320 includes an “open orders summary” panel 322 configured to display a summary of open orders 324. A summary of an open order 324 may include information such as a customer's name, how many items the customer has ordered, and how long ago the order was received, or other suitable information about an open order. In one example, open order summary panel 322 can be configured to display open orders 324 in chronological order, displaying the most recently placed order at the bottom of the list and the displaying the oldest pending order at the top of the list.

User interface 320 also includes an “open order details” panel 326 configured to display the details of a selected open order 324. The open order details panel 326 can be configured to display information such as a list of items included in the order, the quantity of each item, the cost of each item, or other suitable information about an incoming order. The open orders details panel 326 enables a Waitperson 108 to enter messages in a message interface 332 and to communicate the message to the customer 106. For example, a Waitperson 108 may wish to ask for additional information about how to prepare a selected item or to inform a customer 106 that an item is out of stock.

The open order details panel 326 is also configured to enable a Waitperson 108 to identify an item of the of the order as “served.” For example, once a Waitperson 108 delivers an ordered item to the customer 106, Waitperson 108 may mark a checkbox 328 and next to the item in the open order details panel 326 and then click on the “order served” button 330 to indicate that an item has been served. This enables a Waitperson 108 to better track what ordered items have already been delivered and what items still need to be delivered. In one example, open order detail panel 326 can be configured to enable a Waitperson 108 to select all items and to mark all items as “served.”

In one example, order details panel 326 can be configured to enable a Waitperson 108 to edit or override a submitted order. In one example, an edited order is communicated to a customer 106 to confirm acceptance or rejection of the modified order.

In one example, user interface 320 further includes a summary panel 334 configured to display a summary of the total number of orders served for a given day, or anther suitable time frame. The summary panel 334 is further configured to display other suitable information such as a total dollar amount sold for the day, the total amount of gratuity received for a day, and so on.

Once all of the items in an open order have been delivered, the order may be closed. FIG. 3C is another example screen shot of an example user interface 330 of a merchant software application. User interface 330 can be configured to enable a Waitperson 108 to close an order. In particular, user interface 330 enables a Waitperson 108 to review a summary of a completed order, including a total amount due, to adjust the total to include a tip or a special offer, and to close the order by indicating whether the customer 106 paid the bill using a credit card stored by restaurant order server 110 or whether the customer 106 paid offline with cash.

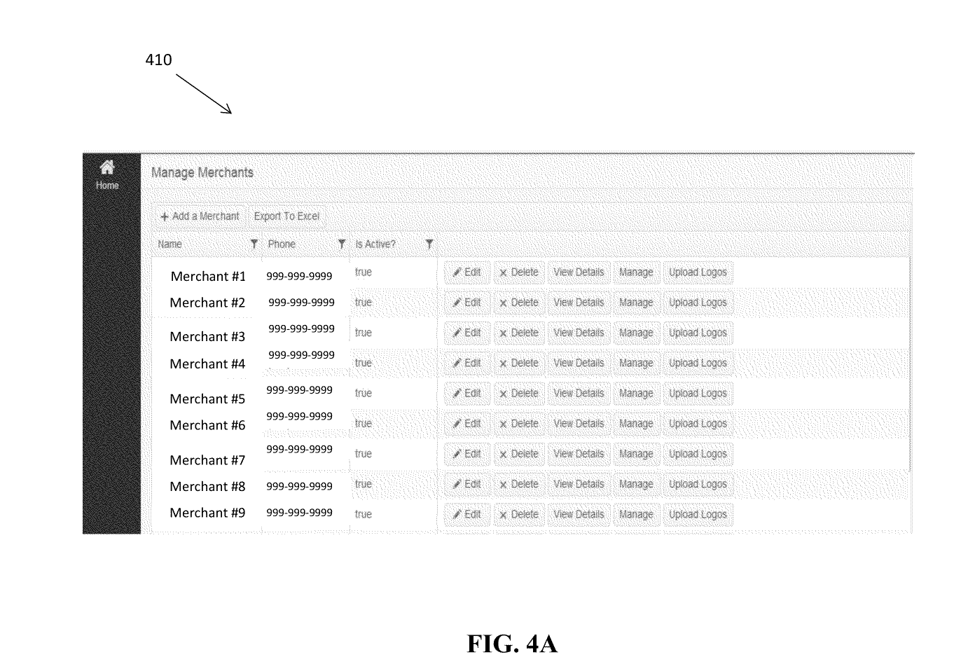

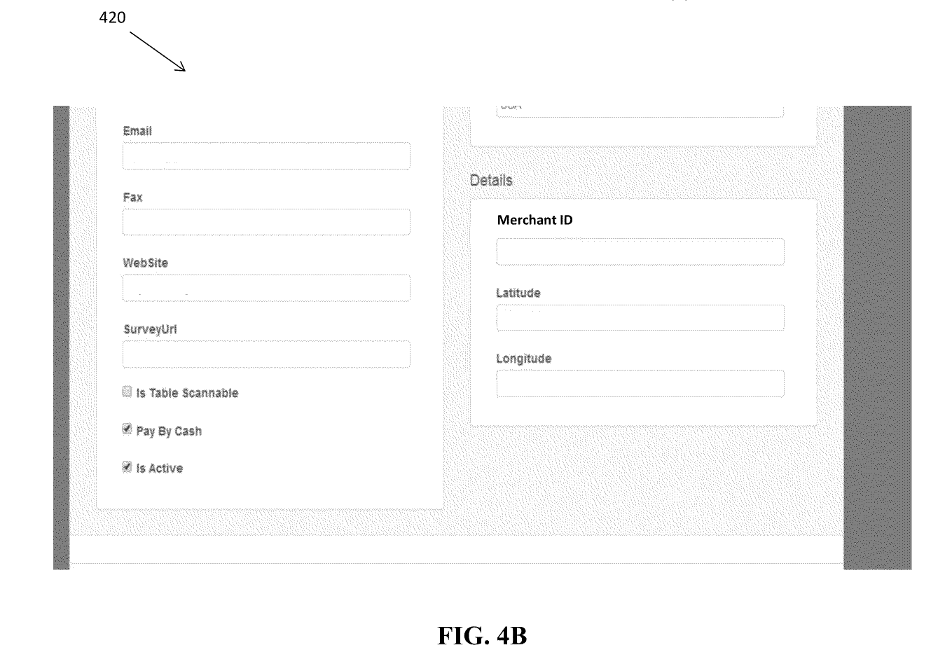

FIG. 4A is an example of a screen shot of an example user interface 410 of a restaurant order server 112 portal software application. The user interface 410 enables an administrator to manage merchants or restaurants associated with system 100 upon verifying the administrators login credentials (not shown). In particular, user interface 410 enables an administrator to define which restaurants a customer 106 may place orders with via customer device 102. User interface 410 enables an administrator to add, edit, and delete a merchant as well as view details about a merchant.

FIG. 4B is another example of a screen shot of an example user interface 420 of a restaurant order server 112 portal software application. User interface 420 enables an administrator to define a restaurant or a merchant, or to view or modify information of an already created merchant. In particular, user interface 420 enables an administrator to define contact information for a merchant, including an email address, a fax number, and a URL. User interface 420 further enables an administrator to define whether the merchant accepts payment by cash or whether the merchant only accepts credit card payments. User interface 420 further enables an administrator to define a merchant's ID number which can be used to initiate a payment transaction with payment processing center 114. User interface 420 further enables an administrator to define a location of a merchant, including latitude and longitude coordinates, which can be used by the customer device 102 to identify the merchant as being in proximity to the customer 106. It should be appreciated that user interface 420 may be configured to enable an administrator to add or modify other suitable information for a merchant.

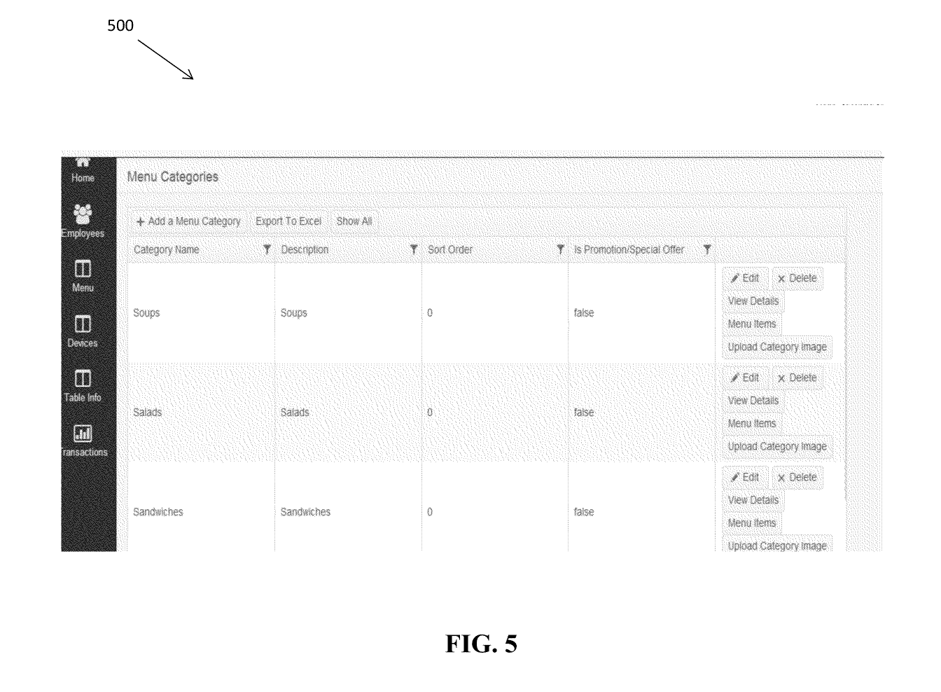

FIG. 5 is an example screen shot of an example user interface 500 of a restaurant order server 112 portal software application. User interface 500 enables a restaurant or merchant administrator to manage menu items made available to a customer 106. In particular, user interface 500 enables a merchant administrator to add an item, including adding a description, a category, an image, a price, and other suitable information about an item. User interface 500 also enables a merchant administrator to edit or delete the items.

User interface 500 further enables a merchant administrator to perform other administrative tasks such as to define which employees or Waitpersons can access system 100 by assigning login credentials and by granting access to specific restaurant devices 104. In one example, user interface 500 further enables a merchant administrator to review completed orders or transactions and issue refunds if appropriate. In one example, user interface 500 further enables a merchant administrator to define locations from which a customer 106 may place an order. For example, a merchant administrator may define table information for a restaurant including whether carryout orders are acceptable, whether a restaurant includes a bar area or a patio, and so on. Such definitions and categorizing for customers 106 may enable a Waitperson 108 to more efficiently deliver orders to a customer 106.

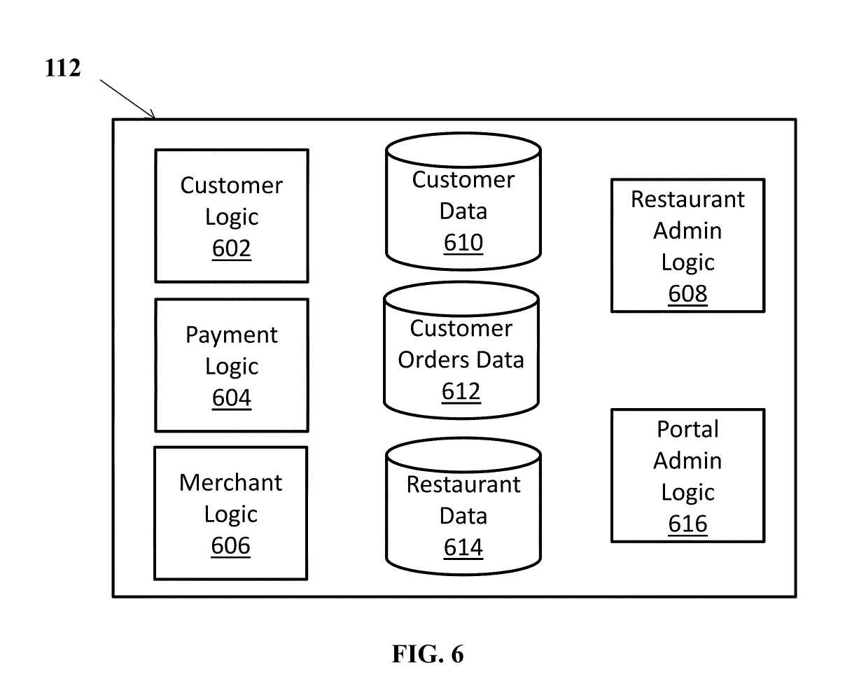

FIG. 6 illustrates a block diagram of an example restaurant order server 112. Restaurant order server 112 includes customer logic 602 configured to receive customer registration data, including credit card information, from a customer device 102 and to store received data in customer data 610. Customer logic 602 is further configured to retrieve information from restaurant data 612, including a list of participating restaurants and menu items associated with a selected restaurant and to communicate restaurant information to a customer device 102. In one example, customer logic 602 can be configured to receive data indicative of a current location of a customer device 102 and in turn communicate to the customer device 102 a list of participating restaurants within proximity of the current location. Customer logic 602 may further be configured to communicate additional suitable information about a restaurant, such as reviews or ratings, a description about the restaurant, and so on, in response to receiving a selection indicative of a restaurant.

Customer logic 602 is further configured to receive customer orders from a customer device 102, including specific items, quantity, and special instructions provided by the customer 106 if applicable, and also configured to store the customer orders in customer orders data 612. Customer logic 602 is further configured to communicate a status of an order to a customer device 102. For example, customer logic 602 may communicate to customer device 102 whether an order is in process or whether it is completed. In one example, customer logic 602 may communicate an estimated time for the order to be completed or delivered. In one example, customer logic 602 may be configured to automatically reject an order based on predefined rules. For example, customer logic may automatically reject an order for an alcoholic drink if stored customer data indicates that the customer 106 is under the age of 21.

In one example, customer logic 602 may be configured to receive information indicating an addition or a modification to an existing order and to update the information stored in customer orders data 612 accordingly.

In one example, customer logic 602 may be configured to communicate a notification that an order cannot be completed if an item is determined to be out of stock, for example.

In one example, customer logic 602 may be configured to analyze current or past items ordered and make recommendations for additional products or provide coupons or discounts on items based on the customer's 106 order history or based on the restaurant's defined rules or promotions.

In one example, customer logic 602 may be configured to communicate a customer's 106 order status, location, photos of food items ordered, reviews of food items ordered, or other suitable information related to a customer's 106 restaurant experience to the customer's 106 social media network such as Facebook.

In one example, customer logic 602 can be configured to receive a “check in” or a notification from a customer device 102 indicative of the customer's 106 presence at a restaurant before receiving an order. A “check in” may be used to notify a Waitperson 108 that a customer 106 is seated and is waiting for assistance before placing an order.

Customer logic 602 is further configured to receive payment information from a customer device 102, including a total amount and a payment method, and to communicate the payment information to payment logic 604. In one example, customer logic 602 is further configured to receive customer feedback for a restaurant.

Payment logic 604 can be configured to communicate payment information to a payment processing center 114 and to receive confirmation of proper processing of the payment from the payment processing center 114. Payment logic 604 is further configured to communicate the payment confirmation to merchant logic 606, which can be configured to interface with restaurant device 104 and to provide confirmation to the Waitperson 108 that payment has been processed successfully. Payment logic 604 is also configured to communicate the payment confirmation to customer logic 602 which is further configured to provide a notification of successful payment to the customer 106 by initiating an email communication to the customer 106 or by communicating a notification to the customer device 102, for example.

In one example, customer logic 602 may be configured to instruct payment logic 604 to authorize or validate a credit card with payment processing center 114 upon an order being submitted in order to ensure the order is a trusted order and to help prevent fraudulent orders.

Merchant logic 606 can be configured to retrieve customer orders information from customer order data 612, as well as associated customer information from customer data 610 and to communicate customer orders information to a restaurant device 104. Merchant logic 606 is further configured to receive indication when orders are delivered and when orders are closed or paid and to update customer orders data 612 accordingly. In one example, merchant logic 606 can be configured to receive a notification indicating that an order or a portion of an order cannot be completed. For example, if an item is out of stock, merchant logic 606 may receive a corresponding notification from a Waitperson 108, via the restaurant device 104, and then update the information stored in customer orders data 612 accordingly.

Merchant logic 606 is also configured to initiate a payment process by receiving payment information from a restaurant device 102, including a total amount and a payment method, and to communicate the payment information to payment logic 604. Thus, either the customer 106 or the Waitperson 108 is able to initiate payment and close an order.

Restaurant order server 112 further includes restaurant admin logic 608 configured to receive restaurant data and to store received data in restaurant data 614. For example, restaurant admin logic 608 can be configured to receive information about menu items, including information such as pricing, detailed descriptions, and photographs, for example. Restaurant admin logic 608 is also configured to receive other suitable information about a restaurant, such as information about personal and devices authorized to access system 100 and to store the received data in restaurant data 614. Restaurant admin logic 608 is further configured to retrieve and update information from restaurant data 614 and to present the information to a restaurant administrator. For example, a restaurant administrator may wish to review information about a restaurant, such as associated menu item, and to occasionally delete or update information.

Restaurant order server 112 further includes portal admin logic 616 configured to receive instructions to add, update, or delete restaurants from restaurant data 614. Portal admin logic 616 is also configured to retrieve restaurant information from restaurant data 614 and to present to an administrator a list of participating restaurants.

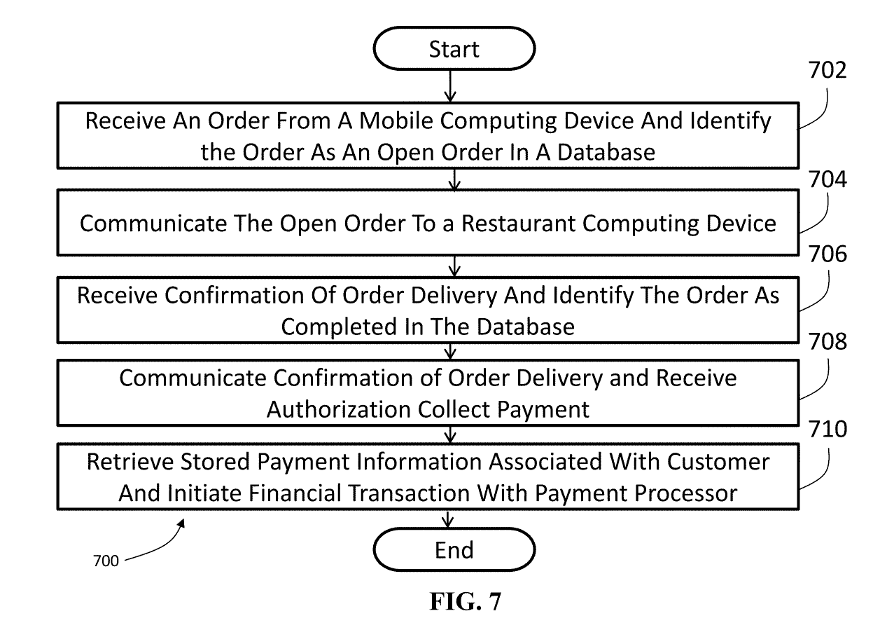

FIG. 7 is a flow chart illustrating the steps of an example method for facilitating orders at a restaurant. At step 702, the restaurant order server 112 receives an order from the customer device 102 and identifies the order as an open order in customer orders data 612. At step 704, the restaurant order server 112 communicates the open order to the restaurant device 104. At step 706, after a Waitperson 108 delivers the order and confirms via the restaurant device 104, the restaurant order server 112 receives the confirmation and of the order delivery and identifies the order as completed in customer orders data 612. At step 708, the restaurant order server 112 communicates the confirmation to the customer device 102 and receives authorization from the customer device 102 to collect payment. At step 710, the restaurant order server 112 retrieves payment information associated with the customer 106 from customer data 610 and initiates a payment transaction using the stored payment information and the restaurant's merchant ID number with payment processing center 114.

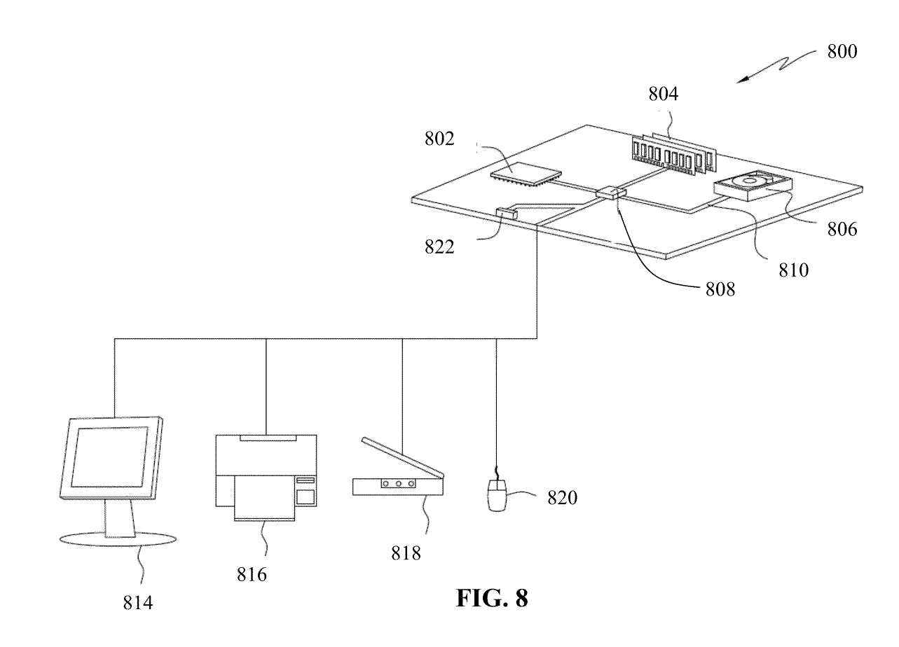

FIG. 8 is a block diagram of an example computing system 800 for implementing an example system for facilitating orders at a restaurant. The example computing system 800 is intended to represent various forms of digital computers, including laptops, desktops, handheld computers, tablet computers, servers, and other similar types of computing devices. As shown, computing system 800 includes a processor 802, memory 804, a storage device 806, and a communication port 808, operably connected by an interface 810 via a bus 812.

Processor 802 processes instructions, via memory 804, for execution within computing system 800. In an example embodiment, multiple processors along with multiple memories may be used.

Memory 804 may be volatile memory or non-volatile memory. Memory 804 may be a computer-readable medium, such as a magnetic disk or optical disk. Storage device 806 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 804 or storage device 806.

Computing system 800 may be coupled to one or more input and output devices such as a display 814, a printer 816, a scanner 818, and a mouse 820.

While example systems, methods, and so on, have been illustrated by describing examples, and while the examples have been described in considerable detail, it is not the intention to restrict or in any way limit the scope of the appended claims to such detail. It is simply not possible to describe every conceivable combination of components or methodologies for purposes of describing the systems, methods, and so on. With the benefit of this application, additional advantages and modifications will readily appear to those skilled in the art. The scope of the invention is to be determined by the appended claims and their equivalents.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

1. A system for facilitating restaurant orders comprising:
at least one processor;
at least one computer-readable tangible storage device; and
program instructions stored on the at least one storage device for execution by the at least one processor, the program instructions comprising;
first program instructions to communicate to a first computing device, data indicative a plurality of restaurants in proximity to the first computing device;
second program instructions to communicate to the first computing device data indicative of a plurality of items associated with a selected restaurant of the plurality of restaurants;
third program instructions to receive data indicative of an order, comprising at least one item of the plurality of items, from the first computing device;
fourth program instructions to communicate data indicative of the order to a second computing device associated with the selected restaurant;
fifth program instructions to communicate, to the first computing device, data indicative of a change in status of the order, responsive to receiving, from the second computing device, data indicative of a confirmation of delivery of the order;
sixth program instructions to retrieve stored data indicative of a customer's preferred payment method, responsive to receiving a request to pay for the order; and
seventh program instructions to initiate a financial transaction with a third computing device using the retrieved preferred payment method.

2. The system of claim 1, wherein the sixth program instructions receive the request to pay for the order from the first computing device.

3. The system of claim 1, wherein the sixth program instructions receive the request to pay for the order from the second computing device.

4. The system of claim 1, wherein the third program instructions receive data indicative of an order comprising a plurality of items, and wherein the fifth program instructions communicate to the first computing device data indicative of a change in status of one of the plurality of items responsive to receiving, from the second computing device, data indicative of a confirmation of delivery of the one of the plurality of items.

5. The system of claim 1, wherein the program instructions further comprise:
eighth program instructions to receive data indicative of a note associated with the order from at one of the first computing device and the second computing device; and
ninth program instructions to communicate data indicative of the note to one of the first computing device and the second computing device.

6. The system of claim 1, wherein the program instructions further comprise eighth program instructions to validate the customer's preferred payment method responsive to the third program instructions receiving data indicative of an order.

7. The system of claim 1, wherein the program instructions further comprise:
eighth program instructions to receive, from the second computing device, data indicative of a modification to the order; and
ninth program instructions to communicate data indicative of the modification to the first computing device and to request data indicative of one of acceptance and rejection of the modification.

8. The system of claim 1, wherein the sixth program instructions receive data indicative of a gratuity amount to be added to a total amount for the order.

9. The system of claim 1, wherein the fifth program instructions to communicate data indicative of a change in status of the order comprises data indicative of a notification for the first computing device to vibrate.

10. The system of claim 1, wherein the program instructions further comprise eighth program instructions to receive a photograph of a user associated with the first computing device and wherein the fourth program instructions to communicate data indicative of the order further communicate the photograph to the second computing device.

11. The system of claim 1, wherein the program instructions further comprise eighth program instructions to communicate to the first computing device a payment receipt corresponding to at least one past order responsive to receiving a request view a history of past orders.

12. A method for facilitating restaurant orders comprising the steps of:
communicating to a first computing device, data indicative a plurality of restaurants in proximity to the first computing device;
communicating to the first computing device data indicative of a plurality of items associated with a selected restaurant of the plurality of restaurants;
receiving data indicative of an order, comprising at least one item of the plurality of items, from the first computing device;
communicating data indicative of the order to a second computing device associated with the selected restaurant;
communicating, to the first computing device, data indicative of a change in status of the order, responsive to receiving, from the second computing device, data indicative of a confirmation of delivery of the order;
retrieving stored data indicative of a customer's preferred payment method, responsive to receiving a request to pay for the order; and
initiating a financial transaction with a third computing device using the retrieved preferred payment method.

13. The method of claim 12, wherein the step of receiving the request to pay for the order comprises receiving the request from the first computing device.

14. The method of claim 12, wherein the step of receiving the request to pay for the order comprises receiving the request from the second computing device.

15. The method of claim 12, wherein the step of receiving data indicative of an order comprises receiving data indicative of an order comprising a plurality of items, wherein the step of communicating data indicative of a change in status of the order comprises communicating to the first computing device data indicative of a change in status of one of the plurality of items responsive to receiving, from the second computing device, data indicative of a confirmation of delivery of the one of the plurality of items.

16. The method of claim 12, further comprising the steps of:
receiving data indicative of a note associated with the order from at one of the first computing device and the second computing device; and
communicating data indicative of the note to one of the first computing device and the second computing device.

17. The method of claim 12, further comprising the step of validating the customer's preferred payment method responsive to receiving data indicative of an order.

18. The method of claim 12, further comprising the steps of:
receiving, from the second computing device, data indicative of a modification to the order; and
communicating data indicative of the modification to the first computing device and requesting data indicative of one of acceptance and rejection of the modification.

19. The method of claim 12, wherein receiving data indicative of a request to pay for an order comprises receiving data indicative of a gratuity amount to be added to a total amount for the order.

20. The method of claim 12, wherein the step of communicating data indicative of a change in status of the order comprises data indicative of a notification for the first computing device to vibrate.

21. The method of claim 12, further comprising the step of receive a photograph of a user associated with the first computing device, wherein the step of communicating data indicative of the order further comprises communicating the photograph to the second computing device.

22. The system of claim 12, further comprising the step of communicating to the first computing device a payment receipt corresponding to at least one past order responsive to receiving a request view a history of past orders.

23. A system for facilitating restaurant orders comprising:
a restaurant order computer server;
a mobile customer computing device in data communication with the restaurant order computer server, and
a mobile restaurant computing device in data communication with the restaurant order computer server;
wherein the mobile customer computing device comprises at least one processor, at least one computer-readable tangible storage device, and program instructions stored on the at least one storage device for execution by the at least one processor, which when executed, cause the mobile customer computing device to:
receive a request from a customer to place an order for at least one item at a selected restaurant and wirelessly communicate the request to the restaurant order computer server;
receive a status of the order from the restaurant order computer server and communicate to the customer the status of the order; and
receive authorization to initiate a payment transaction using a payment method associated with the customer, and communicate the authorization to the restaurant order computer server; and
wherein the restaurant order computer server comprises at least one processor, at least one computer-readable tangible storage device, and program instructions stored on the at least one storage device for execution by the at least one processor, which when executed, cause the restaurant order computer server to:
communicate the order to the mobile restaurant computing device associated with the selected restaurant;
receive notification of a status of the order from the mobile restaurant computing device and communicate the status of the order to the mobile customer computing device; and
receive authorization from the customer mobile computing device to initiate a payment transaction and initiate a payment transaction with a payment processing computer using the payment method associated with the customer.

24. The system of claim 23, comprising a plurality of mobile customer computing devices in data communication with the restaurant order computer server and a plurality of mobile restaurant computing devices in data communication with the restaurant order computer server.

25. The system of claim 23, wherein the program instructions, when executed, further cause the mobile customer computing device to provide a user interface button for repeating a past order with a single button click.
